(19) United States
(12) Patent Application Publication
(10) Pub. No.: US 2019/0280306 A1
(43) Pub. Date: Sep. 12, 2019

(54) TWO-LAYER ANODE FOR MOLTEN CARBONATE FUEL CELLS

(71) Applicant: FuelCell Energy, Inc., Danbury, CT (US)

(72) Inventors: Abdelkader HILMI, Bethel, CT (US); Ethan DEMETER, Jersey City, NJ (US)

(21) Appl. No.: 16/347,902

(22) PCT Filed: Nov. 8, 2017
(86) PCT No.: PCT/US2017/060668

§ 371 Date: May 7, 2019

Related U.S. Application Data
(60) Provisional application No. 62/419,576, filed on Nov. 9, 2016.

(51) Int. Cl. H01M 4/86; H01M 4/90; H01M 8/14

(52) U.S. Cl. CPC H01M 4/8657; H01M 4/9041; H01M 2008/147; H01M 8/145; H01M 2004/8684; H01M 4/9075

(57) ABSTRACT

An anode includes a first layer and a second layer, such that the first layer includes a first active material selected from a NiAl alloy or mixtures of a NiAl alloy and a NiCr alloy, and the second layer includes a second active material and a ceramic material, the second active material selected from a NiAl alloy, a NiCr alloy, and mixtures thereof. A fuel cell includes the anode such that the first layer is disposed adjacent to an anode current collector and the second layer is disposed adjacent to an electrolyte matrix.

### CROSS-REFERENCE TO RELATED PATENT APPLICATION

This application claims the benefit of and priority to U.S. Provisional Patent Application No. 62/419,576 filed on Nov. 9, 2016, the entire disclosure of which is incorporated by reference herein.

### BACKGROUND

The present disclosure relates to anodes for a molten carbonate fuel cell.

Molten carbonate fuel cells (MCFC) are of great interest for power generation, due to their high efficiency and clean conversion of chemical energy into electric energy. Generally carbonate fuel cells operate at intermediate temperatures (575° C.−650° C.) and employ carbonaceous fuels containing carbon dioxide and carbon monoxide. A typical carbonate fuel cell assembly may include a porous Ni anode stabilized against sintering by Cr and/or Al additives and a porous in-situ oxidized and lithiated NiO cathode. The anode and cathode may be separated by a molten alkali carbonate electrolyte, such as Li₂CO₃/K₂CO₃ or Li₂CO₃/Na₂CO₃, contained within a porous ceramic matrix, such as LiAlO₂.

The hydrogen oxidation reaction on the anode is very fast and occurs mainly at the interface of the anode and the electrolyte matrix of a conventional molten carbonate fuel cell. The presence of the reactant gas molecules, such as H₂, near the electrolyte matrix surface may affect the stability of the matrix support material over time during operation of the fuel cell. Long-term exposure of the matrix to a reducing atmosphere created by the reactant gas molecules produces coarsening of the matrix support material particles, thereby producing large pores in the matrix and decreasing the capillary force exerted on the electrolyte by the matrix. The reduced capillary force reduces the ability of the matrix to retain the electrolyte. The formation of the large pores also increases the resistance at the interface of the anode and the matrix due to the electrolyte loss, shortening the life of the fuel cell. Thus, it would be advantageous to provide an anode that mitigates the loss of electrolyte at the interface of the anode and the matrix to improve the lifetime of the fuel cell.

### SUMMARY

In certain embodiments, an anode comprises a first layer and a second layer, wherein the first layer includes a first active material selected from a NiAl alloy or mixtures of a NiAl alloy and a NiCr alloy, and wherein the second layer includes a second active material and a ceramic material, the second active material selected from a NiAl alloy, a NiCr alloy, and mixtures thereof.

In one aspect, the first layer and the second layer further comprise a binder.

In one aspect, the first layer and the second layer have a thickness in a range of 50 μm to 125 μm.

In one aspect, the first active material and the second active material have a particle size in a range of 4 μm to 20 μm.

In one aspect, the first active material comprises a mixture of NiAl alloy and NiCr alloy, with the NiCr alloy present in an amount ranging from 10 wt. % to 50 wt. %.

In one aspect, the second active material comprises a mixture of NiAl alloy in an amount ranging from 10 wt. % to 90 wt. % and NiCr alloy in an amount ranging from 10 wt. % to 90 wt. %.

In one aspect, the ceramic material includes at least one of LiAlO₂, ZrO₂, CeO₂, Li₂ZrO₃, Y₂O₃, Al₂O₃, yttria-stabilized zirconia, or mixtures thereof.

In one aspect, the ceramic material comprises LiAlO₂.

In one aspect, the ceramic material has an average particle size in a range of 0.001 μm to 0.5 μm.

In one aspect, the ceramic material is present in an amount ranging from 10 wt. % to 60 wt. % of the second layer.

In one aspect, the anode further comprises a porous anode support.

In other embodiments, a method for making a two-layer anode comprises forming a first layer from a first slurry, forming a second layer from a second slurry, drying the first layer and the second layer, and laminating the first layer, the second layer, and a nickel-based porous anode support to form the two-layer anode.

In one aspect, the step of forming the first layer and/or the step of forming the second layer independently includes at least one of a tape-casting process, a spray coating process, or a screen printing process.

In one aspect, the step of forming the first layer is a tape-casting process and the step of forming the second layer is a tape-casting process.

In one aspect, the second layer is tape-cast directly on the first layer, without an intervening drying step, and wherein the first layer is tape-cast directly on an electrolyte matrix layer.

In one aspect, the method further comprises preparing the first slurry by mixing a binder solution and an active material, wherein the active material comprises a NiAl alloy or mixtures of a NiAl alloy and a NiCr alloy.

In one aspect, the method further comprises preparing the second slurry by mixing a binder solution, an active material and a ceramic material, wherein the active material comprises a NiAl alloy, a NiCr alloy, or mixtures thereof.

In one aspect, the method further comprises forming a binder solution for inclusion in the first slurry or the second slurry, wherein the step of forming the binder solution includes mixing a binder, a dispersant, a plasticizer and a solvent.

In one aspect, the step of drying the first layer and the second layer is conducted at a temperature in a range of 25° C. to 30° C. for a time in a range of 30 min to 50 min.

In other embodiments, a fuel cell comprises any of the anodes described herein, wherein the first layer is disposed adjacent to an anode current collector and the second layer is disposed adjacent to an electrolyte matrix.

These and other advantageous features will become apparent to those reviewing the disclosure and drawings.

### BRIEF DESCRIPTION OF THE DRAWINGS

FIG. 1 shows a schematic representation of a cross section of a molten carbonate fuel cell including a two-layer anode, according to an embodiment of the present invention.

FIG. 2 shows a schematic representation of cross-section of an apparatus for producing a two-layer anode, according to an embodiment of the present invention.

FIG. 3 shows the ratio of the cell resistance for a conventional single layer anode to the cell resistance for a two-layer anode according to an embodiment of the present invention as a function of fuel cell operation time.

FIG. 4 shows an average particle size of a matrix material as a function of fuel cell operation time for a conventional single layer anode and a two-layer anode according to an embodiment of the present invention.

FIGS. 5A and 5B show Scanning Electron Micrographs (SEM) of the anode side of an electrolyte matrix after operating for more than 2,500 hours for a conventional single layer anode and a two-layer anode according to an embodiment of the present invention, respectively.

### DETAILED DESCRIPTION

The two-layer anodes of the present invention exhibit improved anode wettability for the electrolyte of a molten carbonate fuel cell. The improved wettability of the anodes produces a fuel cell with improved electrolyte matrix stability, electrolyte storage capacity, and service life. The improved properties are due at least in part to the structure of the two-layer anode which locates the anode reaction site away from the electrolyte matrix surface, which reduces or eliminates the degradation of the electrolyte matrix by reaction with the reactant gas molecules.

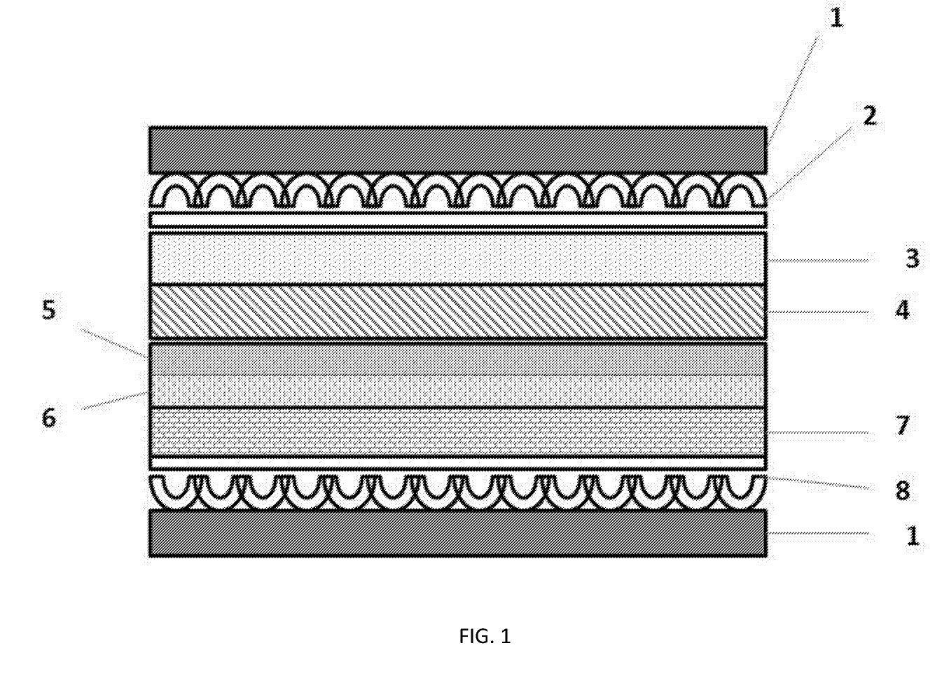

The two-layer anode of the present invention may be included in a molten carbonate fuel cell of the type shown in FIG. 1. The cathode side of the fuel cell includes a bipolar plate 1 adjacent to a cathode current collector 2 which is in contact with a cathode 3. The anode side of the fuel cell includes a bipolar plate 1 adjacent to an anode current collector 8 which is in contact with an anode support 7. The anode support 7 supports an anode that includes an active layer 6 and a flooded layer 5. An electrolyte matrix 4 is disposed between the cathode side and the anode side of the fuel cell. The flooded layer 5 of the anode is adjacent to the electrolyte matrix 4. The cathode, cathode current collector, electrolyte matrix, and bipolar plates may be those commonly employed in molten carbonate fuel cells.

The two-layer anode includes an active layer and a flooded layer. The active layer is the portion of the anode where the fuel oxidation reaction occurs, and is separated from the electrolyte matrix by the flooded layer. The flooded layer is located adjacent to the electrolyte matrix and is completely flooded by the molten carbonate electrolyte. The flooded layer prevents the interaction of the reactants with the electrolyte matrix, reducing the coarsening of the matrix support material and associated electrolyte loss. The active layer and the flooded layer are heterogeneous.

The active layer may include any appropriate anode material. In some embodiments, the active layer includes a NiAl alloy or mixtures of a NiAl alloy and a NiCr alloy. The active layer may include a NiAl alloy along with about 10 wt. % to about 50 wt. % of a NiCr alloy, such as about 20 wt. % to about 50 wt. %, about 20 wt. % to about 40 wt. %, or about 10 wt. % to about 40 wt. %. In one embodiment, the active layer includes about 80 wt. % of a NiAl alloy and about 20 wt. % of a NiCr alloy. The active layer material may be in the form of particles with a size of about 4 μm to about 20 μm. The active layer may have a thickness of about 50 μm to about 125 μm, such as about 75 μm to about 100 μm. The active layer may have an average porosity of about 35% to about 65%, such as about 50% to about 55%.

As utilized herein, a NiAl alloy and a NiCr alloy refer to nickel based alloys with aluminum and chromium additives. In some embodiments, the NiAl and NiCr alloys may include Al and Cr, respectively, in an amount of about 1 wt. % to about 10 wt. %, such as about 3 wt. % to about 5 wt. %. The Al and Cr components of the alloys may reduce the susceptibility of the alloy to creep. In some embodiments, the NiAl and NiCr alloys may be in powder form.

The active layer may include a binder. The binder may be removed by exposure to high temperatures, such as in a heat treatment of the active layer or during operation of the fuel cell. The binder may be present in an amount of about 3 wt. % to about 18 wt. % of the active layer, such as about 3 wt. % to about 10 wt. % or about 15 wt. % to about 18 wt. %. The binder may be any appropriate binder, such as an organic binder. In some embodiments, the binder may be an acrylate binder.

The flooded layer may include any appropriate anode material and a ceramic material. The flooded layer may have a thickness of about 50 μm to about 125 μm, such as about 75 μm to about 100 μm. The flooded layer may have an average porosity of about 35% to about 60%. The anode material included in the flooded layer may be about 100 wt. % NiCr alloy, about 100 wt. % NiAl alloy, or mixtures of NiCr alloy and NiAl alloy. In some embodiments, the anode material in the flooded layer may include about 10 wt. % to about 90 wt. % NiCr alloy and about 10 wt. % to about 90 wt. % NiAl alloy, such as about 20 wt. % NiCr alloy and about 80 wt. % NiAl alloy. The anode material may have a particle size of about 4 μm to about 20 μm. The flooded material may include the anode material in an amount of about 40 wt. % to about 90 wt. %.

The ceramic material included in the flooded layer may be any ceramic material that is capable of increasing the wettability of the flooded layer with respect to the carbonate electrolyte material. In some embodiments, the ceramic material may include LiAlO₂, ZrO₂, CeO₂, Li₂ZrO₃, Y₂O₃, Al₂O₃, yttria stabilized zirconia, or mixtures thereof. LiAlO₂ may be a preferred ceramic material. The ceramic material may include a single ceramic material, two different ceramic materials, three different ceramic materials, or more. The ceramic material may have a particle size of about 0.001 μm to about 0.5 μm. The flooded layer may include the ceramic material in an amount of about 10 wt. % to about 60 wt. %, such as about 20 wt. % to about 60 wt. %. Including the ceramic material in such an amount produces a flooded layer that exhibits sufficient wettability for the electrolyte material to be fully flooded by the electrolyte material. In some embodiments, the flooded layer may exhibit greater than about twice, such as greater than about three times, the electrolyte fill levels and an increased mass-transfer resistance compared to a conventional, or baseline, single-layer anode. An exemplary flooded layer may include a NiCr alloy as an anode material and about 10 vol. % to about 20 vol. % LiAlO₂ as a ceramic material.

The flooded layer may include a binder. The binder may be removed by exposure to high temperatures, such as in a heat treatment of the active layer or during conditioning or start-up of the fuel cell. The binder may be present in an amount of about 3 wt. % to about 10 wt. %. The binder may be any appropriate binder, such as an organic binder. In some embodiments, the binder may be an acrylate binder.

The two-layer anode may be disposed on an anode support. The anode support may be located adjacent to the active layer of the anode. The anode support may be a porous support, such as a screen, mesh, or foam. The anode support may be formed from any appropriate material. In some embodiments, the anode support may be a metallic material, such as nickel.

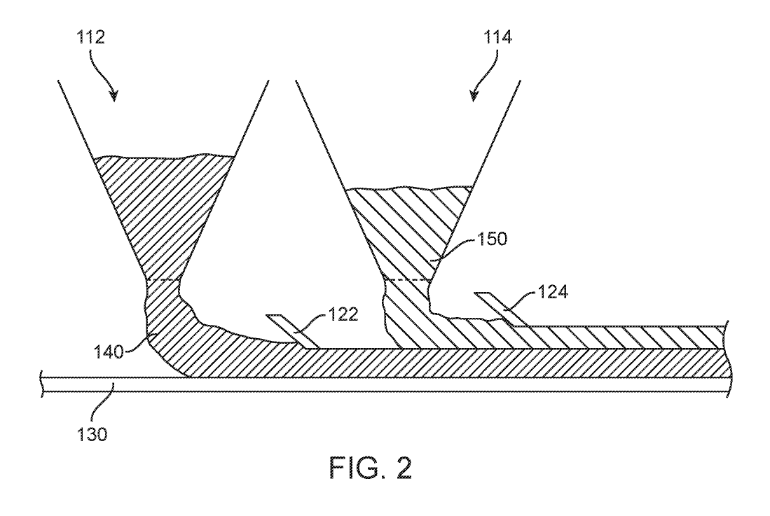

The two-layer anode may be produced by any appropriate process. In some embodiments, the two-layer anode may be formed by a tape-casting process in which the active layer and the flooded layer are formed substantially simultaneously. A tape-casting process may be considered to be substantially simultaneous when the layers are formed on top of one another without an intervening drying step. A substantially simultaneous tape-casting process may be carried out with an apparatus of the type shown in FIG. 2. The process may include a first hopper 112 containing a first slurry 140 and a second hopper 114 containing a second slurry 150. The first hopper 112 may be configured to deposit the first slurry 140 on a substrate 130, and a first doctor blade 122 may be configured to produce a desired thickness of a first layer formed from the first slurry. The second hopper 114 may be configured to deposit the second slurry 150 directly on to the surface of the first layer, and a second doctor blade 124 may be configured to produce a desired thickness of a second layer formed from the second slurry. The doctor blades may be set to produce a first layer and a second layer with a thickness in the ranges described above. The first layer may be the active layer or the flooded layer, with the second layer being the other of the active layer and the flooded layer.

The substrate 130 may be any appropriate material. In some embodiments, the substrate may be an anode support material of the type described above. In other embodiments, the substrate may be an electrolyte matrix. In some embodiments, the substrate may be a material capable of being removed from the anode material, and may be disposable or reusable.

After the tape-casting process, the anode may be dried by any appropriate process. In some embodiments, the tape-cast anode may be dried for a period of about 30 minutes to about 50 minutes. The drying may take place at a temperature of about 25° C. to about 30° C. The drying process may substantially remove a solvent from the tape-cast anode. The dried anode may then optionally be cut to a desired size.

The anode may be laminated to an anode support of the type described above to form an anode assembly. The lamination may be achieved by any appropriate process.

In some alternative embodiments, the two-layer anode may be produced by a process in which an anode active layer and an anode flooded layer are produced separately, and then laminated together. The lamination of the active layer to the flooded layer may occur simultaneously with the lamination to the anode support layer. The individual layers may be produced by a tape casting process, a spray coating process, or a screen printing process. In some embodiments, the flooded layer may be formed directly on the electrolyte matrix.

The slurries employed in the formation of the anode layers may include a binder system and a particulate material capable of forming an active layer or a flooded layer of the type described above. The binder system may include a binder, a dispersant, a plasticizer, and a solvent. The binder may be an organic binder, such as an acryloid based binder. The dispersant may be any appropriate dispersant, such as fish oil, capable of preventing agglomeration of the particles in the slurry. The plasticizer may be any suitable organic plasticizer, such as a phthalate, preferably a butyl benzyl phthalate. The solvent may be any appropriate solvent that is capable of forming a solution of the binder and plasticizer. The solvent may be an organic solvent, such as reagent alcohol.

The binder system is combined with the particulate material to form the slurry by any appropriate process. In some embodiments, the binder system and particulate material is combined by a mixing process. The mixing process may continue for about 1 hour to about 5 hours. In some other embodiments, the binder system and particulate material may be combined by a milling process, such as a ball milling process. The milling process may continue for about 5 hours to about 10 hours. The particulate material may be an anode material of the type described above for the active layer to form a slurry for the production of the active layer. the particulate material may be a mixture of an anode material and a ceramic material of the type described above for the flooded layer to form a slurry for the production of the flooded layer.

The dried anode includes a binder. The binder may be removed at high temperatures, such as the conditioning temperatures of a molten carbonate fuel cell. The binder may be present in the anode when the anode is installed in a fuel cell, such that the binder is removed, or burned out, before the fuel cell reaches operating temperature. In some embodiments, the binder may be removed from the anode before the anode is installed in the fuel cell or may be removed for the purposes of characterizing the anode. The binder of the present invention exhibits complete or substantially complete combustion when treated at high temperature, resulting in complete or substantially complete removal of the binder from the anode.

The two-layer anodes described herein may be employed in any molten carbonate fuel cell.

The two-layer anodes described herein exhibit improved performance. The two-layer anodes produce a reduction in cell resistance at the beginning of cell life of about 20 to about 30 mΩ cm² when compared to a conventional, or baseline, single-layer anode. A fuel cell including the two-layer anode exhibits an improvement in resistance stability of about 30% to about 40% and a reduction in matrix particle coarsening of at least about 60% when compared to a fuel cell including a baseline single-layer anode. The two-layer anodes exhibit improved wettability for the electrolyte material in comparison to a baseline single-layer anode. The two-layer anodes also increase the electrolyte storage capacity and matrix stability of a fuel cell. The two-layer anode design also increases the amount of electrolyte at the anode-to-matrix interface, increasing the contact between the anode and matrix and enabling some electrolyte movement to the active layer to extend cell life.

### Exemplary Embodiments

A lab-scale heterogeneous anode including a flooded layer facing the electrolyte matrix and an active layer for fuel oxidation was produced and tested.

A slurry for the production of the flooded layer was produced from binder system and a particulate material. The binder system was prepared by dissolving an acryloid-based binder, fish oil, and Santicizer® 160 as a plasticizer in reagent alcohol (or an equivalent solvent). Then an appropriate amount of a mixture of Ni-4Cr (4 μm to 20 μm) and 20 vol. % to 60 vol. % LiAlO₂ powder was added and mixed for 1 hour to 5 hours or ball milled for 5 hours to 10 hours to form a flooded layer slurry. The active layer slurry was produced by combining a mixture of 80 wt. % Ni-3Al and 20 wt. % Ni-4Cr and an acrylic based binder solution in an amount of 15 wt. % to 18 wt. %. Anode green sheets were prepared by tape casting simultaneously both slurries at a thickness of 75 μm to 100 μm (3 to 4 mil) each and then dried at 25° C. to 30° C. for 30 minutes to 50 minutes.

Several bench-scale, single cells (250 cm²) and button cells (3 cm²) were tested to determine the performance and stability of the two-layer anode in long-term operation at 650° C. and 160 mA/cm². Each cell assembly included a two-layer anode with the flooded layer facing the matrix and the active layer facing the anode current collector, a porous in-situ oxidized and lithiated NiO cathode, and a porous LiAlO₂ ceramic matrix separating the anode and cathode. The cathode (250 cm²) was filled with an appropriate amount of Li/K or Li/Na electrolyte and an appropriate amount of Li/Na or Li/k electrolyte was also stored in cathode current collector to achieve the required electrolyte balance. Tests with a conventional single-layer baseline anode made of a mixture of a NiAl alloy and a NiCr alloy were also performed under the same test conditions for comparative purposes. In one comparative example, the conventional single-layer baseline anode was made of a mixture of 80 wt. % of a NiAl alloy and 20 wt. % of a NiCr alloy.

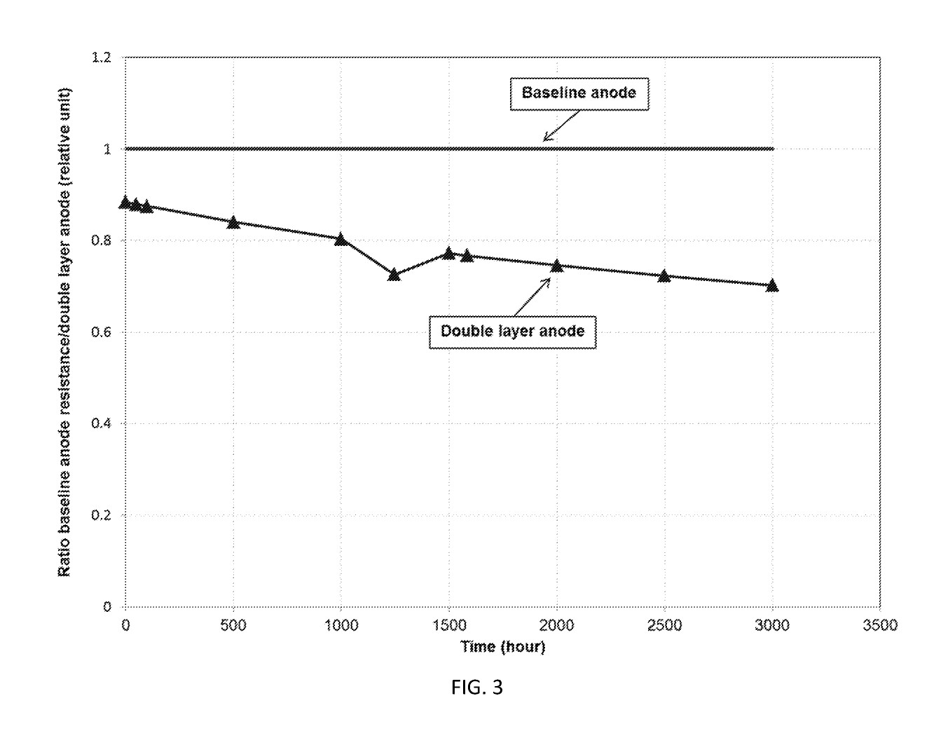

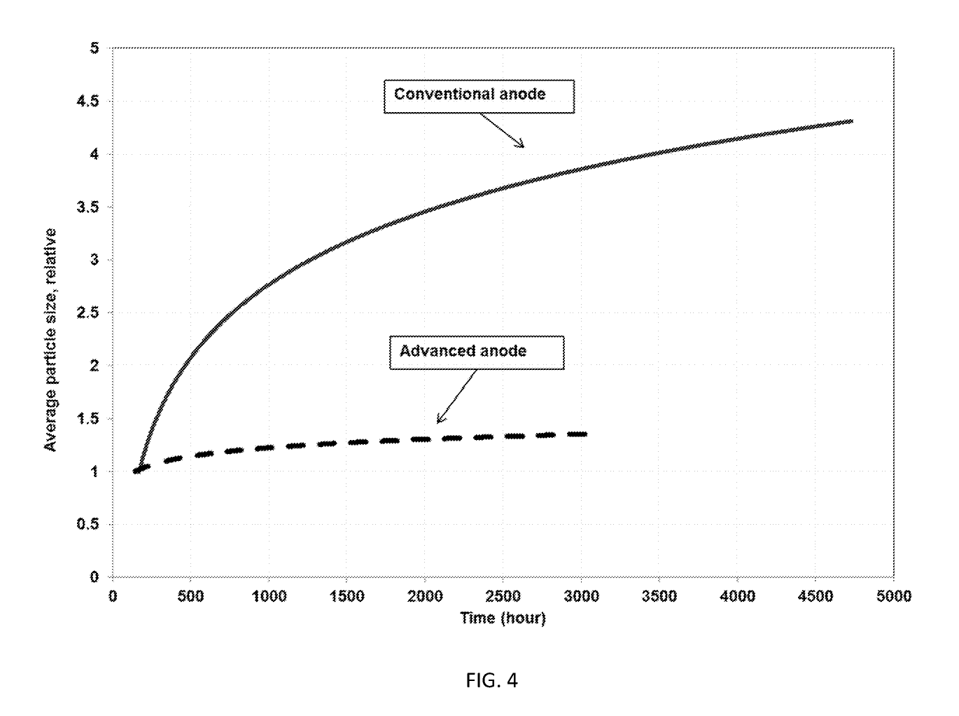

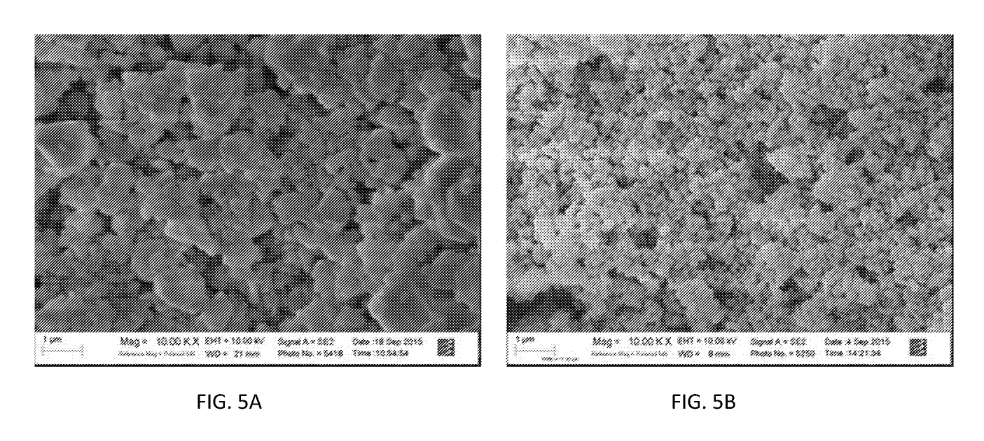

The anode gas for the test was 72.8% H₂-18.2% CO₂-9% H₂O and the cathode gas was 18.5% CO₂-12.1% O₂-66.4% N₂-3% H₂O. The single cell tests were performed at 160 mA/cm² and 75% fuel utilization in the anode and cathode. FIG. 3 shows the resistance stability comparison between the baseline single-layer anode and two-layer anode. The two-layer anode, also referred to as an advanced anode, produces a more than 20 mΩ cm² to 30 mΩ cm² reduction in cell resistance at the beginning of life and 30% to 40% improvement in resistance stability compared to the baseline single-layer anode. The improved cell resistance stability may be attributable to a significant reduction of matrix particle coarsening near the anode side and enhanced electrolyte retention capillary force of the electrolyte matrix. An average matrix (LiAlO₂) particle size measurement of the two-layer anode showed a greater than 60% reduction of matrix coarsening (anode side) compared to a baseline single-layer anode, as shown in FIG. 4. High resolution Scanning Electron Microscope (SEM) post-test analysis of a matrix operated for about 3,000 hours under accelerated conditions confirmed the benefit of the two-layer anode in terms of reducing matrix particle growth and removing the anode reaction away from matrix surface. The matrix from the cell including the baseline single-layer anode exhibited much larger particle size, as shown in FIG. 5A, which is indicative of coarsening of the matrix material that may produce accelerated electrolyte loss. The matrix of the cell including the two-layer anode exhibits much less coarsening of the matrix particles, as demonstrated by the fine and homogeneous LiAlO₂ particles shown in FIG. 5B.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the Figures. It should be noted that the orientation of various elements may differ according to other exemplary embodiments, and that such variations are intended to be encompassed by the present disclosure.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

1. An anode, comprising:
a first layer comprising a first active material, the first active material comprising a NiAl alloy or a mixture of a NiAl alloy and a NiCr alloy, and
a second layer comprising a second active material and a ceramic material, the second active material comprising a NiAl alloy, a NiCr alloy, or a mixture thereof.

2. The anode of claim 1, wherein the first layer and the second layer further comprise a binder.

3. The anode of claim 1, wherein the first layer and the second layer have a thickness in a range of 50 μm to 125 μm.

4. The anode of claim 1, wherein the first active material and the second active material have a particle size in a range of 4 μm to 20 μm.

5. The anode of claim 1, wherein the first active material comprises the mixture of the NiAl alloy and the NiCr alloy, with the NiCr alloy present in an amount in a range of 10 wt. % to 50 wt. %.

6. The anode of claim 1, wherein the second active material comprises a mixture of the NiAl alloy in an amount in a range of 10 wt. % to 90 wt. % and the NiCr alloy in an amount in a range of 10 wt. % to 90 wt. %.

7. The anode of claim 1, wherein the ceramic material comprises of LiAlO₂, ZrO₂, CeO₂, Li₂ZrO₃, Y₂O₃, Al₂O₃, yttria-stabilized zirconia, or a mixture thereof.

8. The anode of claim 7, wherein the ceramic material comprises LiAlO₂.

9. The anode of claim 1, wherein the ceramic material has an average particle size in a range of 0.001 μm to 0.5 μm.

10. The anode of claim 1, wherein the ceramic material is present in an amount in a range of 10 wt. % to 60 wt. % in the second layer.

11. The anode of claim 1, wherein the anode further comprises a porous anode support.

12. A method for making a two-layer anode, comprising:
forming a first layer from a first slurry;
forming a second layer from a second slurry;
drying the first layer and the second layer; and
laminating the first layer, the second layer, and a nickel-based porous anode support to form the two-layer anode.

13. The method of claim 12, wherein the step of forming the first layer and/or the step of forming the second layer is performed using at least one of a tape-casting process, a spray coating process, or a screen printing process.

14. The method of claim 13, wherein the step of forming the first layer is performed using a tape-casting process and the step of forming the second layer is performed using a tape-casting process.

15. The method of claim 12, wherein the second layer is tape-cast directly on the first layer, without an intervening drying step, and wherein the first layer is tape-cast directly on an electrolyte matrix layer.

16. The method of claim 12, further comprising:
preparing the first slurry by mixing a binder solution and an active material, wherein the active material comprises a NiAl alloy or a mixture of a NiAl alloy and a NiCr alloy.

17. The method of claim 12, further comprising:
preparing the second slurry by mixing a binder solution, an active material and a ceramic material, wherein the active material comprises a NiAl alloy, a NiCr alloy, or a mixture thereof.

18. The method of claim 12, further comprising:
forming a binder solution for inclusion in the first slurry or the second slurry, wherein the step of forming the binder solution includes mixing a binder, a dispersant, a plasticizer and a solvent.

19. The method of claim 12, wherein the step of drying the first layer and the second layer is conducted at a temperature in a range of 25° C. to 30° C. for a time in a range of 30 min to 50 min.

20. A fuel cell, comprising:
an anode according to claim 1, wherein the first layer is disposed adjacent to an anode current collector and the second layer is disposed adjacent to an electrolyte matrix.
